(19) United States
(12) Patent Application Publication
(10) Pub. No.: US 2004/0127085 A1
(43) Pub. Date: Jul. 1, 2004

(54) Connector for a pin grid array integrated circuit device

(76) Inventors: James Chen, Taipei Hsien (TW); Jung-Wu Chen, Tao-Yuan City (TW)

Correspondence Address: FROMMER LAWRENCE & HAUG, 745 FIFTH AVENUE- 10TH FL., NEW YORK, NY, 10151, US

(21) Appl. No.: 10/687,078

(22) Filed: Oct. 16, 2003

(30) Foreign Application Priority Data
Oct. 18, 2002 (TW) 091216690
Mar. 5, 2003 (TW) 092203327

(51) Int. Cl. H01R 13/625

(52) U.S. Cl. 439/342

(57) ABSTRACT

A connector includes a dielectric substrate formed with a plurality of terminal mounting holes, each of which extends from a first mounting surface to a second mounting surface opposite to the first mounting surface. A plurality of conductive terminals are mounted respectively in the terminal mounting holes. Each conductive terminal has a coupling end portion disposed adjacent to the first mounting surface, and a solder tail extending from the coupling end portion outwardly of a corresponding terminal mounting hole and bent to form a solder contact that projects from the second mounting surface of the dielectric substrate.

### CROSS-REFERENCE TO RELATED APPLICATION

This application claims priority of Taiwanese Application No. 091216690, filed on Oct. 18, 2002, and Taiwanese Application No. 092203327, filed on Mar. 5, 2003.

### BACKGROUND OF THE INVENTION

1. Field of the Invention

The invention relates to a connector, more particularly to a connector adapted for soldering to a circuit board using a surface mount technology (SMT).

2. Description of the Related Art

FIGS. 1 and 2 illustrate a conventional connector 3 for a pin grid array integrated circuit device 4, such as a central processing unit. The integrated circuit device 4 has a plurality of insert pins 41, as shown in FIG. 2. The conventional connector 3 includes a dielectric substrate 32, a plurality of conductive terminals 34, a mounting seat 31, and a driving piece 33. The dielectric substrate 32 has a first mounting surface 322, and a second mounting surface 323 opposite to the first mounting surface 322. The dielectric substrate 32 is formed with a plurality of terminal mounting holes 321, each of which extends from the first mounting surface 322 to the second mounting surface 323. The conductive terminals 34 are mounted respectively in the terminal mounting holes 321. Each conductive terminal 34 has a coupling end portion 341 disposed adjacent to the first mounting surface 322, and a soldering end portion 342 disposed adjacent to the second mounting surface 323. The soldering end portion 342 of each conductive terminal 34 is formed with a downwardly opening e recess 3421 that is filled with a tin ball 343 there in such that the tin ball 343 projects from the second mounting surface 3.23 of the dielectric substrate 32, as shown in FIG. 2. The mounting seat 31 is mounted movably on the first mounting surface 322 of the dielectric substrate 32, and is formed with a plurality of through holes 311, each of which is registered with a corresponding one of the terminal mounting holes 321. The driving piece 33 is operable so as to drive the mounting seat 31 to move to a connecting position, where the insert pins 41 of the integrated circuit device 4 contact electrically and respectively the coupling end portions 341 of the conductive terminals 34 then the insert pins 41 of the integrated circuit device 4 mounted on the mounting seat 31 extend respectively through the through holes 311 in the mounting seat 31 and into the terminal mounting holes 321 in the dielectric substrate 32.

The conventional connector 3 can be connected to a circuit board formed with a plurality of solder pads (not shown), which correspond respectively to the tin balls 343 on the conventional connector 3, using a known surface mount technology. However, during soldering, liquid tin resulting from the molten tin balls 343 disperses along the conductive terminals 34 such that tin can accumulate on the coupling end portions 341 of the conductive terminals 34 to adversely affect connection between the insert pins 41 of the integrated circuit device 4 and the coupling end portions 341 of the conductive terminals 4. Furthermore, due to the presence of the tin balls 343 with relatively low conductivity, noises occur during high-frequency signal transmission.

### SUMMARY OF THE INVENTION

Therefore, the object of the present invention is to provide a connector for a pin grid array integrated circuit device that is adapted be soldered to a circuit board using a surface mount technology without the need for tin balls.

According to the present invention, a connector comprises:

a dielectric substrate having a first mounting surface, and a second mounting surface opposite to the first mounting surface, the dielectric substrate being formed with a plurality of terminal mounting holes, each of which extends from the first mounting surface to the second mounting surface; and

a plurality of conductive terminals mounted respectively in the terminal mounting holes in the dielectric substrate, each of the conductive terminals having a coupling end portion disposed adjacent to the first mounting surface, and a solder tail extending from the coupling end portion outwardly of a corresponding one of the terminal mounting holes and bent to form a solder contact that projects from the second mounting surface of the dielectric substrate.

### BRIEF DESCRIPTION OF THE DRAWINGS

Other features and advantages of the present invention will become apparent in the following detailed description of the preferred embodiments with reference to the accompanying drawings, of which;

FIG. 1 is a perspective view of a conventional connector;

FIG. 2 is a fragmentary schematic sectional view of the conventional connector;

FIGS. 3 to 8 are fragmentary schematic sectional views showing the first to sixth preferred embodiments of a connector according to the present invention;

FIG. 9 is a fragmentary schematic sectional view showing the seventh preferred embodiment of a connector according to the present invention;

FIGS. 10 and 11 are fragmentary perspective views showing two embodiments of a dielectric substrate of the seventh preferred embodiment; and

FIGS. 12 to 15 are fragmentary schematic sectional views showing the eighth to eleventh preferred embodiments of a connector according to the present invention.

### DETAILED DESCRIPTION OF THE PREFERRED EMBODIMENTS

Before the present invention is described in greater detail, it should be noted that like elements are denoted by the same reference numerals throughout the disclosure.

Referring to FIG. 2, the first preferred embodiment of a connector 1 according to the present invention is shown to include a dielectric substrate 12, and a plurality of conductive terminals 2. The connector 1 is adapted for use with a pin grid array (PGA) integrated circuit device (not shown).

The dielectric substrate 12 has a first mounting surface 121, and a second mounting surface 122 opposite to the first mounting surface 121. The dielectric substrate 12 is formed with a plurality of terminal mounting holes 123, each of which extends from the first mounting surface 121 to the second mounting surface 122.

The conductive terminals 2 are mounted respectively in the terminal mounting holes 123. Each of the conductive terminals 2 has a coupling end portion 21 disposed adjacent to the first mounting surface 121, and a solder tail 22 extending from the coupling end portion 21 outwardly of a corresponding one of the terminal mounting holes 123 and bent to form a solder contact 221 that projects from the second mounting surface 122 of the dielectric substrate 12. The coupling end portion 21 of each conductive terminal 2 is adapted to contact electrically a corresponding one of a plurality of signal pins on the integrated circuit device. The solder contact 221 of each conductive terminal 2 is adapted to be connected electrically to a corresponding one of a plurality of solder pads on a circuit board (not shown) so as to establish electrical connection between the integrated circuit device and the circuit board. In this embodiment, the solder contact 221 of each conductive terminal 2 is generaly U-shaped and has a distal end 222 that abuts against the second mounting surface 122 of the dielectric substrate 12.

FIGS. 4, 4 and 6 illustrate respectively the second, third and fourth preferred embodiments of a connector 1a, 1b, 1c according to this invention, which are substantially similar to the first preferred embodiment. In these embodiments, the solder contact 221a, 221b, 221c of each conductive terminal 2a, 2b, 2c is formed with a shape that is slightly different from that of the solder contact 221 in the first preferred embodiment.

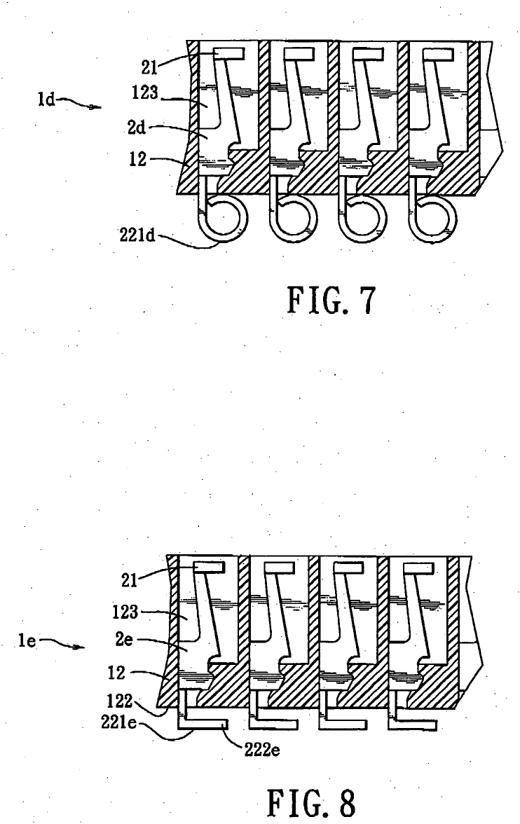

FIG. 7 illustrates the fifth preferred embodiment of a connector 1d according to this invention, which is a modification of the first preferred embodiment. In the fifth preferred embodiment of FIG. 7, the solder contact 221d of each conductive terminal 2d is formed into a loop.

FIG. 8 illustrates the sixth preferred embodiment of a connector 1e according to this invention, which is a modification of the first preferred embodiment. In the sixth preferred embodiment of FIG. 8, the solder contact 221e of each conductive terminal 2e is generally L-shaped. At the same time, the distal end 222e of the solder contact 221e is spaced apart from the second mounting surface 122 of the dielectric substrate 12.

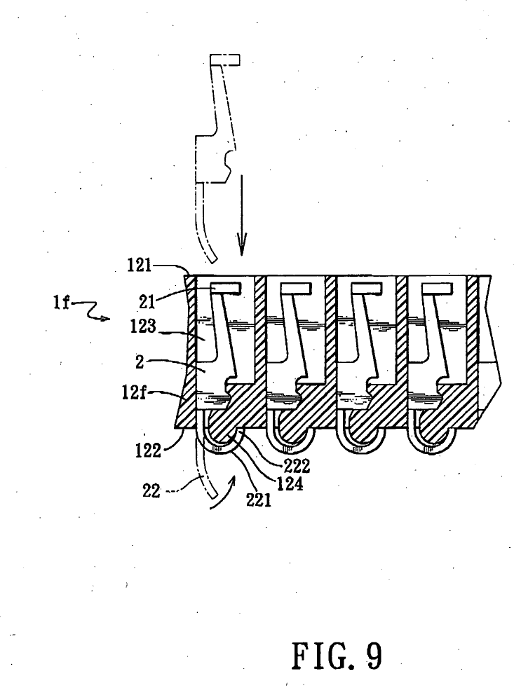

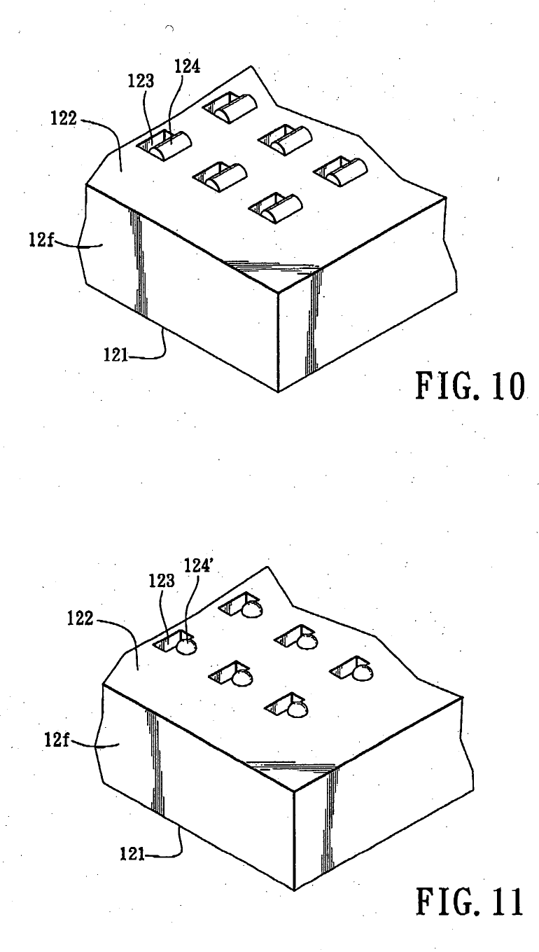

FIGS. 9 to 11 illustrate the seventh preferred embodiment of a connector 1f according to this invention, which is a modification of the first preferred embodiment. Unlike the previous embodiments, the second mounting surface 122 of the dielectric substrate 12f is formed with a plurality of bumps 124, each of which is disposed adjacent to a corresponding one of the mounting holes 123 in the dielectric substrate 12f. The solder tail 22 of each conductive terminal 2 is bent to extend under and to contact an adjacent one of the bumps 124, as shown in FIG. 9. Each bump 124 may be formed with a semi-cylindrical shape, as shown in FIG. 10. Alternatively, each bump 124′ may be formed with a semi-spherical shape, as shown in FIG. 11.

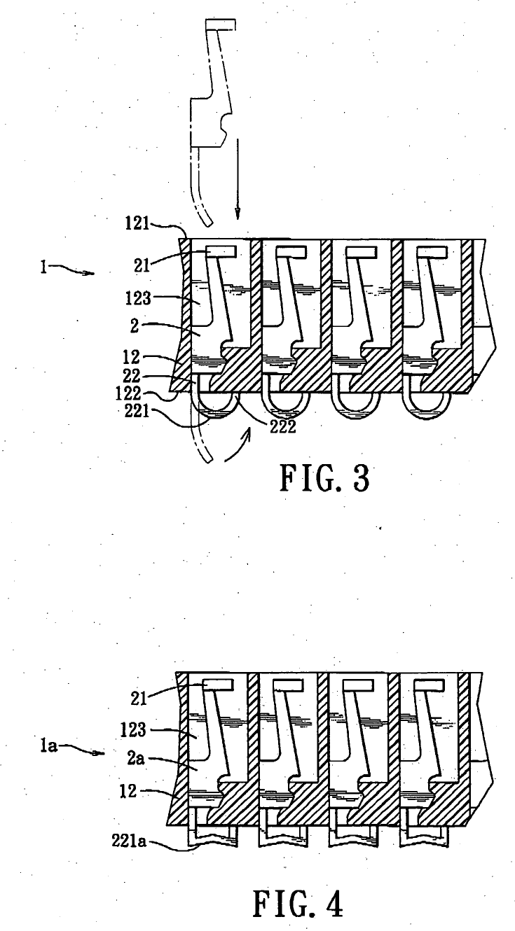

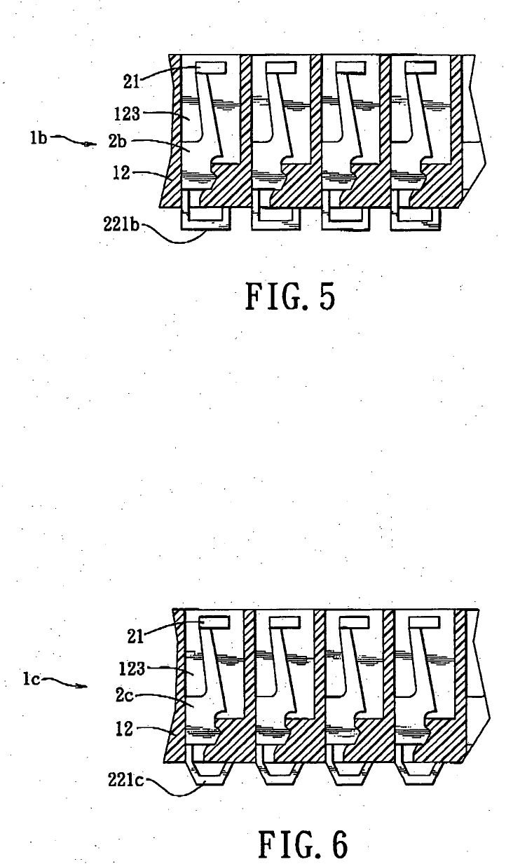

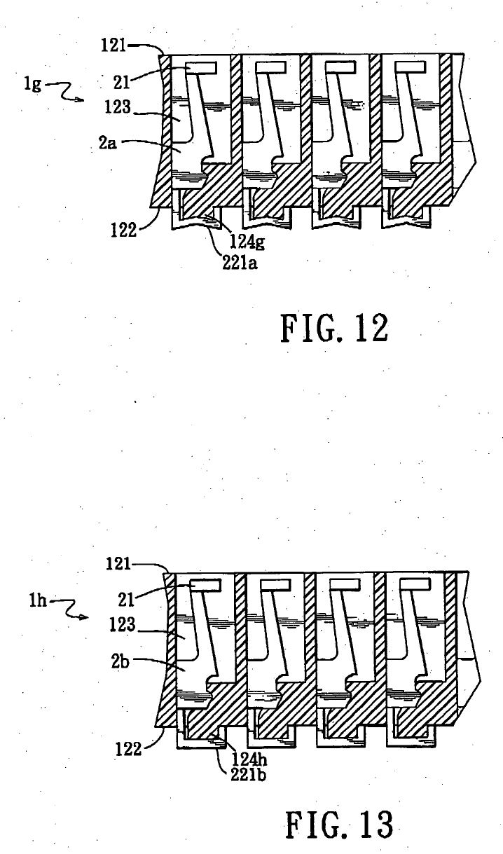

FIG. 12 illustrates the eighth preferred embodiment of a connector 1g according to this invention, which is a modification of the first preferred embodiment. In the eighth preferred embodiment of FIG. 12, the solder contact 221a of each conductive terminal 2a is formed with a shape slightly different from that of the solder contacts 221 of the first and seventh preferred embodiments in FIGS. 3 and 9. Furthermore, each bump 124g has a cross section different from that of the bump 124 in the seventh preferred embodiment.

FIG. 13 illustrates the ninth preferred embodiment of a connector 1h according to this invention, which is a modification of the first preferred embodiment. In the ninth preferred embodiment of FIG. 13, the solder contact 221b of each conductive terminal 2b is formed with a shape slightly different from that of the solder contacts 221, 221a of the seventh and eighth preferred embodiments in FIGS. 9 and 12. Furthermore, each bump 124h is formed with a rectangular shape.

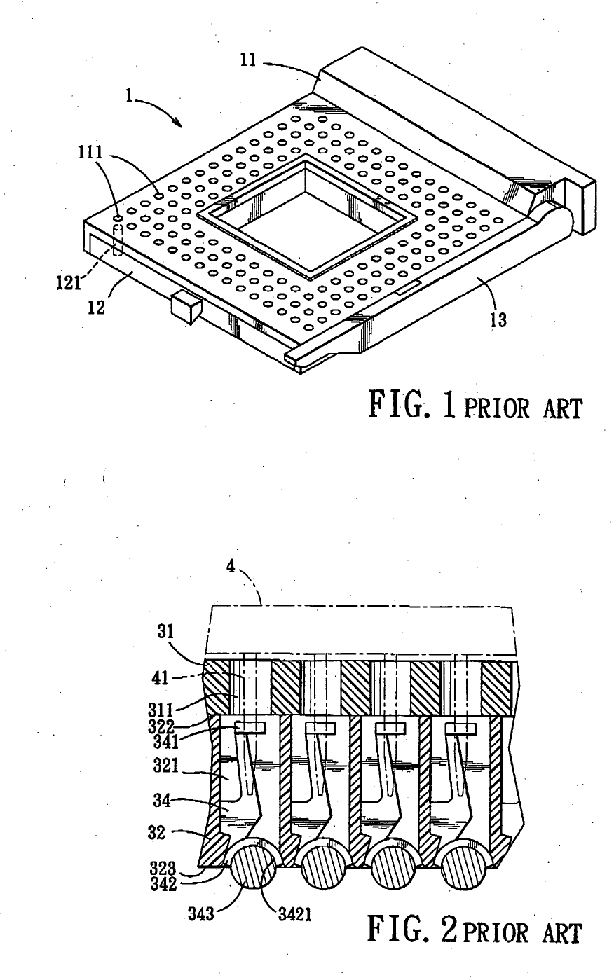

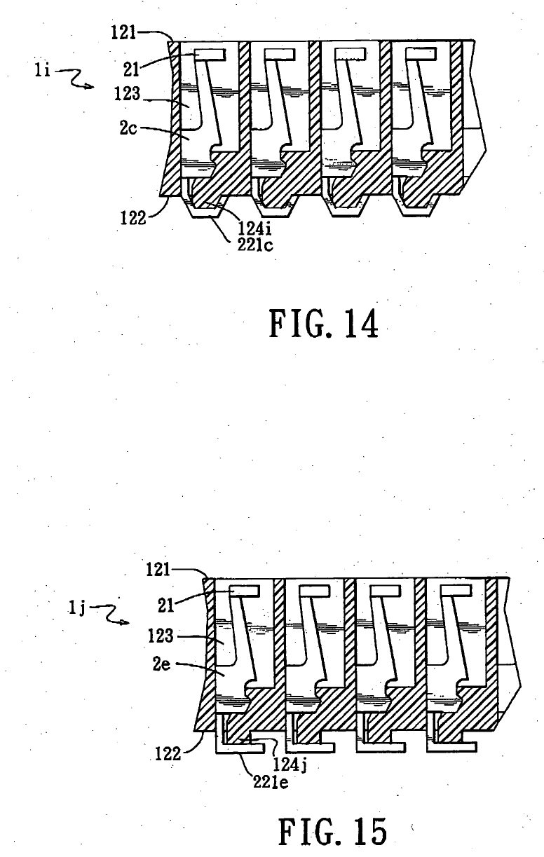

FIG. 14 illustrates the tenth preferred embodiment of a connector 1i according to this invention, which is a modification of the first preferred embodiment. In the tenth preferred embodiment of FIG. 14, the solder contact 221c of each conductive terminal 2c is formed with a shape slightly different from that of the solder contacts 221, 221a, 221b of the seventh, eighth and ninth preferred embodiments in FIGS. 9, 12 and 1i. Furthermore, each bump 124i is formed with an inverted trapezoid shape FIG. 15 illustrates the eleventh preferred embodiment of a connector 1j according to this invention, which is a modification of the first preferred embodiment. In the eleventh preferred embodiment of FIG. 15, the solder contact 221e of each conductive terminal 2e is generally L-shaped. Furthermore, each bump 124j is formed with a rectangular shape.

The following are some of the advantages attributed to the connector of the present invention:

1. Since the solder tail of each conductive terminal is bent to form the solder contact, a complicated process for implanting tin balls on the conductive terminals during fabrication of the connector can be omitted. Therefore, fabrication costs of the connector of this invention can be reduced.

2. Due to the presence of the bumps, the solder tail of each conductive terminal can be bent to extend under and to contact an adjacent bump such that the solder contacts have substantially the same shapes and sizes. Furthermore, because the tin balls are not in use, accumulation of tin material on the coupling end portions of the conductive terminals during soldering on a circuit board can be avoided.

3. Since the solder contacts, which can be made of copper, gold or other alloy with relatively low resistance, are adapted to be connected electrically and directly to the solder pads on the circuit board using a known surface mount technology without the use of tin balls having relatively higher resistance, the connector of this invention possesses relatively higher conductivity so as to minimize generation of noises during high-frequency signal transmission.

4. When misalignment of any one of the solder contacts occurs after soldering, the connector of this invention can be recycled after heating to remove the connector from the circuit board.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A connector comprising:
a dielectric substrate having a first mounting surface, and a second mounting surface opposite to said first mounting surface, said dielectric substrate being formed with a plurality of terminal mounting holes, each of which extends from said first mounting surface to said second mounting surface; and
a plurality of conductive terminals mounted respectively in said terminal mounting holes in said dielectric substrate, each of said conductive terminals having a coupling end portion disposed adjacent to said first mounting surface, and a solder tail extending from said coupling end portion outwardly of a corresponding one of said terminal mounting holes and bent to form a solder contact that projects from said second mounting surface of said dielectric substrate.

2. The connector as claimed in claim 1, wherein said solder contact of each of said conductive terminals is generally U-shaped and has a distal end that abuts against said second mounting surface of said dielectric substrate.

3. The connector as claimed in claim 1, wherein said solder contact of each of said conductive terminals is formed into a loop.

4. The connector as claimed in claim 1, wherein said solder contact of each of said conductive terminals is generally L-shaped.

5. The connector as claimed in claim 1, wherein said second mounting surface of said dielectric substrate is formed with a plurality of bumps, each of which is disposed adjacent to a corresponding one of said terminal mounting holes in said dielectric substrate, said solder tail of each of said conductive terminals being bent to extend under and to contact an adjacent one of said bumps.

6. The connector as claimed in claim 5, wherein said solder contact of each of said conductive terminals is generally U-shaped and has a distal end that abuts against said second mounting surface of said dielectric substrate.

7. The connector as claimed in claim 6, wherein each of said bumps is formed with one of a semi-cylindrical shape, a semi-spherical shape, a rectangular shape and an inverted trapezoid shape.

8. The connector as claimed in claim 5, wherein said solder contact of each of said conductive terminals is generally L-shaped.
